(19) United States
(12) Patent Application Publication
(10) Pub. No.: US 2008/0155565 A1
(43) Pub. Date: Jun. 26, 2008

(54) Automatic Completion of Command Line Arguments

(75) Inventor: Haranadh Poduri, Hyderabad (IN)

Correspondence Address: SAWYER LAW GROUP LLP, P.O. BOX 51418, PALO ALTO, CA, 94303, US

(73) Assignee: International Business Machines Corporation, Armonk, NY (US)

(21) Appl. No.: 11/613,947

(22) Filed: Dec. 20, 2006

(51) Int. Cl. G06F 9/46

(52) U.S. Cl. 719/320

(57) ABSTRACT

A method and system for facilitating user interaction with a shell. In one embodiment, the method and system include receiving command input in a command line, wherein the command input comprises a partial command argument, wherein the partial command argument is followed by one of a space character and a tab; completing a command argument in the command line based on the command input; validating a command argument and values associated with the command argument if the partial command argument is followed by the space; and displaying context sensitive help based on the command input if the partial command argument is followed by the tab, wherein the context sensitive help comprises a syntax tree for the command argument.

### FIELD OF THE INVENTION

The present invention relates to operating systems, and more particularly to shell functionality.

### BACKGROUND OF THE INVENTION

Shells are the outermost layer of an operating system or application, and provide a user interface for users to interact with an operating system or application. An example of a shell is a UNIX shell. A problem with conventional shells is that it can be difficult for a user to remember all of the arguments for basic commands (e.g., grep, sed, tar, etc.). Consequently, users typically need to go through the man pages (i.e., a manual) repeatedly and return to the shell to specify the proper command arguments for the commands.

Accordingly, what is needed is a method and system for facilitating user interaction with a shell. The present invention addresses such a need.

### SUMMARY OF THE INVENTION

A method and system for facilitating user interaction with a shell is disclosed. In one embodiment, the method and system include receiving command input in a command line, wherein the command input comprises a partial command argument, wherein the partial command argument is followed by one of a space character and a tab; reading a mapping repository to determine and load at least one library corresponding to the partial command argument; completing a command argument in the command line based on the command input, wherein if more than one command argument is available, the shell program automatically displays a plurality of command argument options that start with the partial command argument; limiting the display of command argument options by mutual exclusion, wherein only command argument options that are compatible with the command argument are displayed; automatically updating the command line with the other command arguments upon which the command argument depends; displaying a set of valid values for each command argument option of the plurality of command argument options; validating a command argument and values associated with the command argument if the partial command argument is followed by the space; displaying errors with the command argument if there are any errors; displaying context sensitive help based on the command input if the partial command argument is followed by the tab, wherein the context sensitive help comprises a syntax tree for the command argument; and displaying specific completion instructions for each command argument.

According to the method and system disclosed herein, the generation of command arguments is optimized.

### BRIEF DESCRIPTION OF THE DRAWINGS

FIG. 1 is a block diagram of a computer system in accordance with one embodiment.

FIG. 2 is a flow chart showing a method for facilitating the generation of command arguments in accordance with one embodiment.

### DETAILED DESCRIPTION OF THE INVENTION

The present invention relates to operating systems, and more particularly to shell functionality. The following description is presented to enable one of ordinary skill in the art to make and use the invention, and is provided in the context of a patent application and its requirements. Various modifications to the preferred embodiment and the generic principles and features described herein will be readily apparent to those skilled in the art. Thus, the present invention is not intended to be limited to the embodiments shown, but is to be accorded the widest scope consistent with the principles and features described herein.

A method and system in accordance with the present invention for facilitating user interaction with a shell is disclosed are disclosed. The method and system provide intelligent shell functionality that guides a user as the user enters command lines on a command line prompt in a shell. Embodiments facilitate the user when generating command arguments by completing command arguments as the user is entering them, providing command argument options for the user to select, verifying commands and corresponding values, and displaying context sensitive help to the user. As a result, embodiments optimize the generation of command arguments.

Although the present invention disclosed herein is described in the context of UNIX commands, the present invention may apply to other types commands such as DOS commands, and still remain within the spirit and scope of the present invention. Embodiments may also apply to user defined shells, as well interfaces in which a user may run commands by specifying command arguments. Furthermore, embodiments may apply to database query executing shells (e.g., Structured Query Language (SQL) Plus for Oracle, iSQL for Sybase, etc.)

We can consider a typical example of “select” command and its arguments and make the same above invention applicable to complete the arguments.

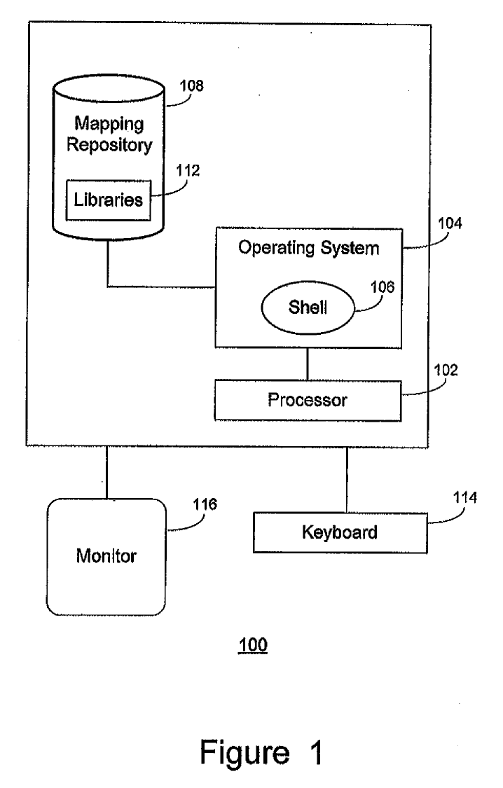

FIG. 1 is a block diagram of a computer system 100 in accordance with one embodiment. The computer system 100 includes a processor 102, an operating system 104 having a shell 106, a mapping repository 108 having one or more libraries 112, a keyboard 114 and a monitor 116. In one embodiment, the shell 106 may be any user interface utilized for generating and executing commands. Example shells may include UNIX shells (e.g., bash, sh, ksh, csh, etc.) and DOS in Windows. As describes in more detail below, the shell 106 helps the user to enter correct command arguments with proper values. In one embodiment, the shell 106 may utilize the mapping repository 108 to map command names to command arguments in the libraries 112. In one embodiment, commands may be implemented as shared objects in a library 112. In one embodiment, the shell 106 has the necessary information as to which library should be opened during run time for a particular command.

As described in more detail below, the shell 106 guides the user each time the user asks for help (e.g., entering a tab) or each time the user types in a separator (e.g., typing a <space>). For example, if the user types in the command “find <tab>,” the shell 106 not only loads the library but also displays necessary help for the user. In one embodiment, the shell 106 invokes a help function (e.g., contextHelp) for the command implemented in the shared library.

In one embodiment, command arguments are arguments for a command. The shell may validate a given command argument while implementing it. Conventionally, a user runs a command many times before finally entering the correct command arguments with proper values. As described in more detail below, embodiments described herein avoid the user having to run the commands multiple times, because the shell 106 may invoke validation functions defined in the command. The validation functions may be invoked automatically or when the users make a request.

In one embodiment, argument properties may include: value type (e.g., string, integer, file name, directory name, etc.); maximum occurrences; minimum occurrences; a description; list type (e.g., finite set of values); default value; an optional/mandatory selection; one or more dependencies with other command arguments; minimum values; maximum values; an alias name, etc. In one embodiment, any command may have the following abstract functions implemented in the form of a shared library: initializeArgProperties, runCommand(context *current_context), contextHelp(context *current_context), checkValidityDisplayHelp(context *current_context), argHelpDisplay(Argument *current_argument), listOfArgs(Argument *argNameStartingWith), checkArgumentValidity(Argument *argName).

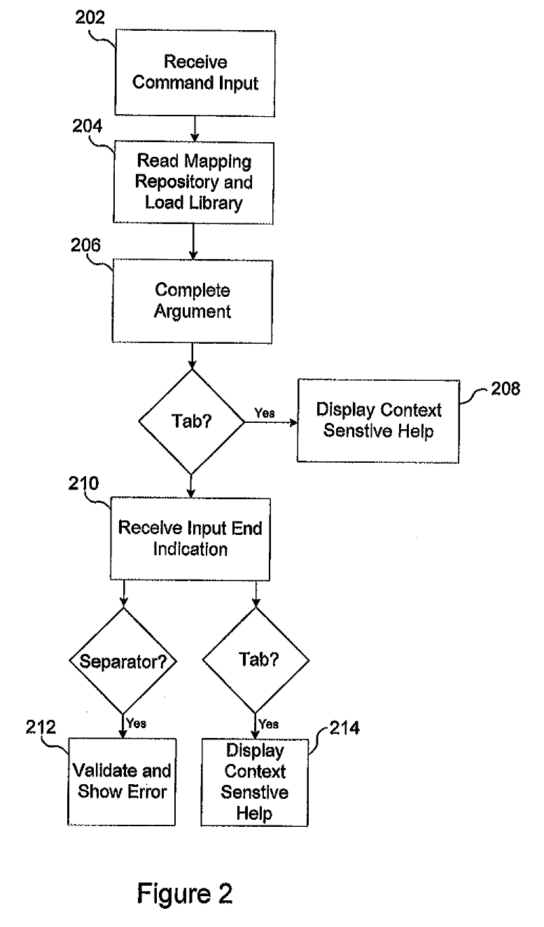

FIG. 2 is a flow chart showing a method for facilitating the generation of command arguments in accordance with one embodiment. Referring to both FIGS. 1 2 together, the process begins in step 202 where the shell 106 receives command input from a user. As described in more detail below, the shell 106 responds to the command input depending on the context of the command input. In one embodiment, the command input may include a command name or a partial command argument followed by a field separator character or a tab. In one embodiment, the field separator character may be the <space> character.

In step 204, the shell 106 reads the mapping repository 108 to determine and load a library 112 corresponding to the partial command argument or command name. In step 206, the shell 106 invokes an appropriate routine (e.g., intializeArgProperties) from the library 112. In one embodiment, InitializeArgProperites is a function that each command library utilizes to initialize all of its command line arguments. In one embodiment, the command library may also keep initialization of auto/static variables (if any) in this function.

In one embodiment, the step 206 occurs whether the user inputs a field separator character or a tab. Although the present invention disclosed herein is described in the context of a field separator character and a tab, these are only examples of characters that may be utilized to implement embodiments described herein. The present invention may utilize other characters, and still remain within the spirit and scope of the present invention.

In one embodiment, if the command input includes only a command name followed by a tab, the shell 106 displays an entire syntax tree (as there are no arguments specified yet). As described in more detail below, if the command input includes a partial command argument followed by a tab, the shell 106 displays the context sensitive help related to the argument that has been partially completed.

In one embodiment, if the command input includes a partial command argument, the shell 106 automatically completes the command argument in the command line. In one embodiment, the shell 106 automatically displays the command argument as soon as the user starts entering the argument. For example, if the user enters -na and <TAB>, all the command arguments that start with the partial command argument (e.g., -na) are displayed. The following is an example result:

$find -m<TAB>
-mmin
-mount
-mtime

In one embodiment, if only one option exists, the command argument on the command line is automatically updated with that option. The following is an example result:

$find -na <TAB>
-name

In one embodiment, the shell 106 also automatically completes dependent command arguments. For example, if a command argument (e.g., -abc) is dependent on another command argument (e.g., -def), the shell 106 automatically updates the command line with the depended command argument (e.g., -def) in case the user first entered the dependent command argument (e.g., -abc).

In one embodiment, the shell 106 displays a set of valid values for each command argument option. If a command argument has a finite set of valid values, the shell 106 may displays the valid values after the user inputs the command argument. The following is an example result:

| $find -type <TAB> | |
|---|---|
| b | block (buffered) special |
| c | character (unbuffered) special |
| d | directory |
| p | named pipe (FIFO) |
| f | regular file |
| l | symbolic link |
| s | socket |

In one embodiment, the shell 106 limits the display of the command argument options by mutual exclusion. For example, if a command argument (e.g., -abc) is mutually exclusive with one or more other command argument options (e.g., -def and ghi), only the command argument options that are compatible with the command argument (e.g., -abc) are displayed (i.e., compatible command arguments not including—def and ghi).

In one embodiment, a tab may indicate that the user needs some assistance. Referring again to FIG. 2, in step 208, if the user inputs a tab after the command name or partial command argument, the shell 106 displays context sensitive help information corresponding to the command. In one embodiment, the help information may include, for example, a syntax tree for the command. In one embodiment, the shell 106 displays the command syntax as soon as the user enters the command input (e.g., partial command argument and separator). The following is an example result:

```
    $find <TAB>
    Usage: find [path...] [expression]
    default path is the current directory; default expression is -print
    expression may consist of:
    operators (decreasing precedence; -and is implicit where no others are given):
    (EXPR)! EXPR -not EXPR EXPR1 -and EXPR2 EXPR1 -and EXPR2
    EXPR1 -o EXPR2 EXPR1 -or EXPR2 EXPR1, EXPR2 options (always true): -
daystart -depth -follow -help
    -maxdepth LEVELS -mindepth LEVELS -mount -noleaf -version -xdev tests (N
can be +N or −N or N): -amin N -anewer FILE -atime N -cmin N
    -cnewer FILE -ctime N -empty -false -fstype TYPE -gid N -group NAME -
ilname PATTERN -inamePATTERN -inum N -ipath PATTERN -iregex PATTERN
    -links N -lname PATTERN -mmin N -mtime N -name PATTERN -newer FILE
    -nouser -nogroup -path PATTERN -perm [+−]MODE -regex PATTERN
    -size N[bckw] -true -type [bcdpfls] -uid N -used N -user NAME -xtype
[bcdpfls]
    actions: -exec COMMAND; -fprint FILE -fprint0 FILE -fprint FILE FORMAT -
ok COMMAND ; -print -print0 -printf FORMAT -prune -ls
```

Referring still to FIG. 2, in one embodiment, these steps described above loop until step 210 when the shell 106 receives an input end indication (e.g., until the user completes the command). In one embodiment, the user may indicate that the command is complete by pressing (enter).

In one embodiment, in step 212, if the input end indication is accompanied with a field separator, the shell 106 validates the current context of the command argument and its values. The shell 106 may also display context sensitive help based on the command arguments that have already been inputted. The shell 106 may display an error, if any, and prompt the user to take necessary action. If there are any errors, the shell 106 may display the errors with the command arguments that the user has inputted up until that point.

In one embodiment, in step 212, if the input end indication is accompanied with a field separator, the shell 106 displays context sensitive help information corresponding to the command, as described above in step 208.

Embodiments may also enable the user to customize completion even further, as the shell may display specific completion instructions for each command argument. For example, a mail command may required email addresses on the command line. In one embodiment, the shell 106 may provide a list of available email addresses for the command line, and the user may select one or more of the email addresses. For example, the list may include the email addresses of friends or associates to whom the user may want to send an email. In another example, the user may use particular commands to connect to particular remote hosts and also to complete hostnames for those particular hosts. For example, the user may utilize a host name (hash) completion feature or a special editor command in the shell to read host names from a file (e.g., /etc/hosts).

In one embodiment, a complete command (e.g., tcsh) may define custom completions. For example, in an email system, a user may use commands directly from a shell prompt (instead of first starting an email command interpreter and entering commands at the interpreter's own prompt). In on embodiment, a mail folder name may be used as a command argument. A mail folder name may start with a “+” or sometimes with an “@,” and may appear anywhere in a command line. In one embodiment, mail folders may be stored anywhere in a file system, even on a networked file system on a remote computer. The following are example command lines that may be put in a setup file:

```
    Set up MH folder name completion for “folder”, “refile”, “scan”,
“show”: folders
-task recurse | \
    sed -o ‘/DELETE/d’ e ‘s/o/-/’ > $HOME/Mail/folderList
    complete $folder, refile, scan, show:
    ‘C@*?’ cat $HOME/Mail/folderList @’
```

In one embodiment, the first command builds a file named folderlist with a list of strings (e.g., folder names). A user may not want completion to include folder names that the user never looks in. Accordingly, the shell 106 may enable the user to filter the folder output with a command to exclude the unwanted names (e.g., folder names ending with “DELETE”). The following are example lines of a folderlist:

-drafts
-inbox
-jobs
-jobs/bay area
-jobs/miscellaneous

Another command, complete, may start with a list in brackets of commands that may be used to complete folder names. One argument may match any pattern included with backquotes from a cat (catalog) command, which provides the contents of a folderlist. The following is an example of completing a folder name:

tcsh> scan +j TAB
tcsh> scan +jobs/m TAB
tcsh> scan +jobs/miscellaneous last: 20

According to the system and method disclosed herein, the present invention provides numerous benefits. For example, embodiments of the present invention saved the user time when typing in command lines arguments. Embodiments of the present invention also provide the user with the convenience of not having to remember the command argument options for all of the basic commands.

A method and system in accordance with the present invention for facilitating user interaction with a shell has been disclosed. The method and system provide intelligent shell functionality that guides a user as the user enters command arguments on a shell. Embodiments facilitates the user when generating command arguments by completing command arguments as the user is entering them, providing command argument options for the user to select, verifying commands and corresponding values, and displaying context sensitive help to the user. As a result, embodiments optimize the generation of command arguments.

The present invention has been described in accordance with the embodiments shown. One of ordinary skill in the art will readily recognize that there could be variations to the embodiments, and that any variations would be within the spirit and scope of the present invention. For example, the present invention can be implemented using hardware, software, a computer readable medium containing program instructions, or a combination thereof. Accordingly, many modifications may be made by one of ordinary skill in the art without departing from the spirit and scope of the appended claims.

What is claimed is:

1. A method for facilitating user interaction with a shell, the method comprising:
receiving command input in a command line, wherein the command input comprises a partial command argument, wherein the partial command argument is followed by one of a space character and a tab;
reading a mapping repository to determine and load at least one library corresponding to the partial command argument;
completing a command argument in the command line based on the command input, wherein if more than one command argument is available, the shell program automatically displays a plurality of command argument options that start with the partial command argument;
limiting the display of command argument options by mutual exclusion, wherein only command argument options that are compatible with the command argument are displayed;
automatically updating the command line with the other command arguments upon which the command argument depends;
displaying a set of valid values for each command argument option of the plurality of command argument options;
validating a command argument and values associated with the command argument if the partial command argument is followed by the space;
displaying errors with the command argument if there are any errors;
displaying context sensitive help based on the command input if the partial command argument is followed by the tab, wherein the context sensitive help comprises a syntax tree for the command argument; and
displaying specific completion instructions for each command argument.

2. The method of claim 1 further wherein the shell is a UNIX shell.

3. The method of claim 1 further wherein the shell is a DOS shell.

4. A system comprising:
a processor; and
an operating system operatively coupled to the processor, wherein the operating system comprises a shell operative to:
receive command input in a command line, wherein the command input comprises a partial command argument, wherein the partial command argument is followed by one of a space character and a tab;
read a mapping repository to determine and load at least one library corresponding to the partial command argument;
complete a command argument in the command line based on the command input, wherein if more than one command argument is available, the shell program automatically displays a plurality of command argument options that start with the partial command argument;
limit the display of command argument options by mutual exclusion, wherein only command argument options that are compatible with the command argument are displayed;
automatically update the command line with the other command arguments upon which the command argument depends;
display a set of valid values for each command argument option of the plurality of command argument options;
validate a command argument and values associated with the command argument if the partial command argument is followed by the space;
display errors with the command argument if there are any errors;
display context sensitive help based on the command input if the partial command argument is followed by the tab, wherein the context sensitive help comprises a syntax tree for the command argument; and
display specific completion instructions for each command argument.

5. The system of claim 4 wherein the shell is a UNIX shell.

6. The system of claim 4 wherein the shell is a DOS shell.
